(19) United States
(12) Patent Application Publication
(10) Pub. No.: US 2011/0112847 A1
(43) Pub. Date: May 12, 2011

(54) INCENTIVIZED PROGRAM

(76) Inventors: Zachary W. Ball, Oak Park, MI (US); Joshua L. Ball, Waterford, MI (US)

(21) Appl. No.: 12/941,160

(22) Filed: Nov. 8, 2010

Related U.S. Application Data
(60) Provisional application No. 61/258,880, filed on Nov. 6, 2009.

(51) Int. Cl. G06Q 30/00

(52) U.S. Cl. 705/1.1

(57) ABSTRACT

A method for providing a participant with an incentive which includes providing a web browser including a clue, an interactive content, and a pre-defined selectable area within the interactive content. The clue comprises information for directing the participant to select the pre-defined selectable area. The pre-defined selectable area has a location which is initially unknown to the participant. The method further includes deducing the location of the pre-defined selectable area by the participant using the clue; selecting the pre-defined selectable area by the participant; and providing an incentive to the participant for selecting the pre-defined selectable area.

### CROSS-REFERENCE TO RELATED APPLICATION

This application claims the benefit of U.S. Provisional Application 61/258,880 which was filed on Nov. 6, 2009, the entire disclosure of which is hereby incorporated by reference.

### BACKGROUND OF THE INVENTION

1. Field of the Invention

The present invention pertains to an incentivized program. More particularly, the present invention pertains to an interactive incentivized program. Even more particularly, the present invention pertains to an interactive incentivized web-based computer program.

2. Description of the Prior Art

Computer programs and websites exist which use incentives to encourage users to engage in, or view, particular webpages. For example, U.S. Pat. No. 6,102,406 to Miles et al. discloses an Internet-based service which operates a scavenger hunt in which participants are required to answer questions using information obtained from one or more websites visited in response to hints suggesting where the information can be found. In the invention disclosed by Miles, the program operates on an Internet-wide basis, and each preceding question must be successfully answered before the next question is presented. A similar program is disclosed by U.S. Patent Publication No. 2007/0226062 to Hughes et al.

U.S. Patent Publication No. 2005/0027596 to Bender et al. discloses a system and method for directing consumer traffic over the Internet by embedding a foreign object within properties located on affiliates' websites and encourages consumers to search for those objects. This program requires both affiliates and consumers to register with a third party in order to participate.

However, there are several issues with these programs as they currently exist. For instance, it is difficult to attract web traffic to scavenger hunt type games which provide a prize for locating the goal. This is because the users are competing with each other for the prize, and therefore the users are reluctant to notify others about the scavenger hunt to avoid increasing the competition against them.

In addition, many scavenger hunt type games take place on an Internet-wide basis. Companies which sponsor these online events have little desire to draw web traffic to any website other than their own. Therefore, there is a desire to provide incentive-based web browsing within only the company's website.

Furthermore, interactive incentive programs which exist in the prior art require substantial upfront development costs to create an interactive incentivized website. This is a relatively new method for attracting web traffic and gathering data from consumers, and therefore companies are reluctant to dedicate the money necessary for such a program without having definite assurance as to its success. Furthermore, these substantial development costs are prohibitive to many smaller start-up companies on the Internet, thus barring them from engaging with consumers via an incentivized program.

The present invention, as is detailed hereinbelow, seeks to resolve these issues by providing a customizable interactive incentivized web-based program which: (1) encourages participants to promote the incentivized program to others using viral marketing; (2) operates only within webpages specified by the company which is providing the incentivized program; and (3) allows companies to quickly and economically create and operate an incentivized program using an existing infrastructure program.

### SUMMARY OF THE INVENTION

The present invention provides a method for providing a participant with an incentive comprising:
(a) providing a web browser including a clue, an interactive content, and a pre-defined selectable area within the interactive content, the clue comprising information for directing the participant to select the pre-defined selectable area, and the pre-defined selectable area having a location which is initially unknown to the participant;
(b) deducing the location of the pre-defined selectable area by the participant using the clue;
(c) selecting the pre-defined selectable area by the participant; and
(d) providing an incentive to the participant for selecting the pre-defined selectable area.

Further to this aspect of the invention, the pre-defined selectable area is not visible to the participant and its location is unknown. Therefore, the participant uses the clue to locate the selectable area. In addition, a hint may be provided along with the clue to further assist the participant.

The present invention also provides an incentivized web-based computer program comprising:
(a) a clue containing information;
(b) an interactive content;
(c) a selectable area located within the interactive content, the location of the selectable area being unknown to a participant of the program, the information in the clue provided for directing the participant to select the selectable area; and
(d) an incentive which is made available to the participant upon selecting the selectable area.

In yet another aspect, the present invention also provides a computer for operating an incentivized web-based software program comprising:
(a) a computer comprising a processor for operating a software program;
(b) the software program comprising a clue containing information for directing a participant of the program, an interactive content, a selectable area located within the interactive content, the location of the selectable area being unknown to the participant of the program, the clue being provided to direct the participant to select the selectable area; and
(c) an incentive which is made available to the participant upon selecting the selectable area.

For a more complete understanding of the present invention, reference is made to the following detailed description and accompanying drawing. In the drawing, like reference characters refer to like parts throughout the views in which:

### BRIEF DESCRIPTION OF THE DRAWINGS

FIG. 1 is a view of a first embodiment of the present invention hereof showing the clue, the interactive content, the hint, the selectable area, and the incentive;

FIG. 2 is an exemplary embodiment showing the clue, the interactive content, the hint, and the selectable area (shown in phantom);

FIG. 3 is an exemplary embodiment showing the computer comprising the incentivized web-based software program; and

FIG. 4 is a conceptual view of the present invention including the clue, interactive content, and selectable area, along with an incentive, a survey page, and a registration page.

### DETAILED DESCRIPTION OF THE PREFERRED EMBODIMENT

At the outset it is to be noted that although the ensuing disclosure is made with reference to an incentivized program for use with a website, the present invention is not so limited. Rather the present invention has equal efficiency in conjunction with Internet-wide applications, as well as non-Internet-based applications.

In accordance with the present invention and as shown generally in FIG. 1, there is provided a method for providing a participant with an incentive comprising: (a) providing a clue 10, an interactive content 12, and a pre-defined selectable area 14 within the interactive content 12, the clue 10 comprising information for directing the participant to select the pre-defined selectable area 14; and (b) providing an incentive 16 to the participant when the participant selects the pre-defined selectable area 14.

An objective of the present invention is to attract and engage participants, or consumers, in exchange for granting the participant with an incentive 16. In another aspect, the present invention can be intended to gather information from participants, such as demographics or contact information, for purposes such as marketing research or the creation of distribution lists.

The present invention also provides for an incentivized web-based program 18 comprising: (a) a clue 10 containing information for directing a participant of the program 18; (b) an interactive content 12; (c) a selectable area 14 located within the interactive content 12, the location of selectable area 14 being unknown to the participant of the program 18, wherein the clue 10 directs the participant to select the selectable area 14; and (d) an incentive 16 which is made available to the participant upon selecting the selectable area 14.

The present invention includes providing the participant with the clue 10. The clue 10 can comprise text, an image, video, audio, or any other medium which is known to one of ordinary skill in the art for providing the participant with the information for directing the participant to select the pre-defined selectable area 14. The clue 10 is provided to assist the participant in locating the pre-defined selectable area 14, as is discussed in further detail below.

The interactive content 12 is provided as well. The interactive content 12 can also comprise text, an image, video, audio, or any other medium which is known to one of ordinary skill in the art. The interactive content 12 comprises any audio or visual aspects which exist in a computer program and are perceived by the participant.

Located within the interactive content 12 is the selectable area 14. The selectable area 14 is transparent with respect to the interactive content 12, and its location is not known to the participant. The clue 10 provides information which assists the participant in locating the selectable area 14. For example, the selectable area 14 can comprise a transparent shape which is placed atop a specific location of the interactive content 12. The selectable area 14 can also comprise an object within the interactive content 12, such as an image, text, a hyperlink, or the like.

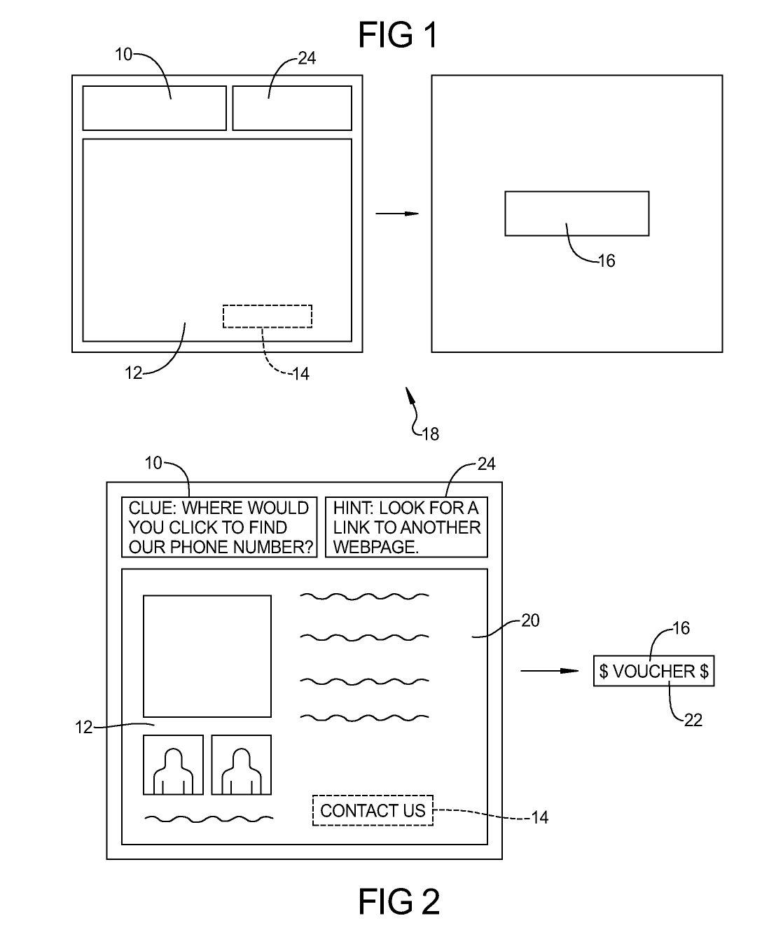

In an exemplary embodiment shown in FIG. 2, the interactive content 12 comprises content from a webpage 20, the clue 10 comprises a question, such as “Where would you click to find our phone number?” and the selectable area 14 comprises a transparent box located on a web link tided “Contact Us.” In this example, the participant receives an incentive 16 upon successfully clicking within the transparent box over the “Contact Us” link. It is to be understood that this exemplary embodiment is provided for purposes of further understanding the present invention, and the present invention is not so limited.

As stated above, the present invention provides the participant with the incentive 16 upon successfully locating and selecting the selectable area 14. The incentive 16 can comprise a tangible item (such as a physical item which can be delivered to the participant) (not shown), a printable item 22 (such as a printable coupon or voucher), a hyperlink (not shown) which leads to a reward (such as access to a premium portion of a website, a hyperlink to download a song, virtual goods for use in an online role-playing game, or the like), or any other reward as understood by one having ordinary skill in the art. It is to be appreciated that the present invention contemplates any incentive 16 which can be used to entice the participant in engaging with the program 18. It is further understood that the incentive 16 does not need to be granted to the participant following successful location of the selectable area 14; rather it can be provided to the participant either before or while the participant locates the selectable area 14 as well.

In addition to the clue 10, the present invention can also provide a hint 24 for further assisting the participant in successfully locating the selectable area 14. The hint 24 can be text, an image, a number, or the like. Although the hint 24 is not required for use herein, it can optionally be provided. In furtherance of the exemplary embodiment above regarding the “Contact Us” hyperlink, a text hint 24 can be provided, such as “Look for a link to another webpage.” The hint 24 can also be configured to appear to the participant after a predetermined time period. For example, if a participant has not located the selectable area 14 after a predetermined time period (e.g. thirty seconds), then the hint 24 can appear to the participant to provide further assistance in locating the selectable area 14.

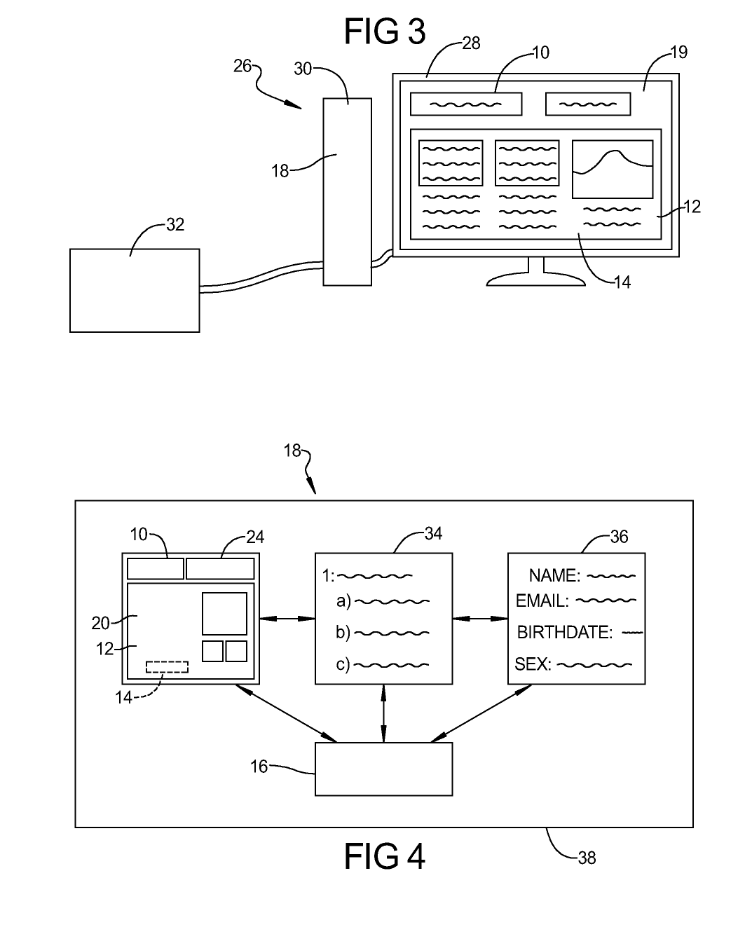

In yet another embodiment as shown in FIG. 3, the present invention can comprise a computer 26 having a display 28 for operating an incentivized web-based software program 18 which is operated through a web browser 19. The web browser 19 can comprise any suitable type of web browser which is well-known to one having ordinary skill in the art, such as Internet Explorer, Firefox, Google Chrome, and so forth. The computer 26 comprises a processor 30 for operating the software program 18 which is displayed on the display 28. The software program 18 comprises the clue 10 containing information for directing the participant of the program 18, the interactive content 12, and the selectable area 14 located within the interactive content 12. The location of the selectable area 14 is unknown to the participant of the program 18, and the clue 10 is provided to direct the participant to select the selectable area 14. The incentive 16 is made available to the participant upon correctly selecting the selectable area 14. Preferably the computer 26 is connected to the Internet 32 to allow the program 18 to access the web-based content.

In operation, the present invention can be utilized in a web-based program 18 which includes the interactive webpage 20 and the incentive 16 to the participant. The interactive webpage 20 comprises the clue 10, the interactive content 12, the selectable area 14, and optionally, the hint 24. The web-based program 18 can also include webpages which comprise at least one request for information from the participant, such as a survey 34 and/or a participant registration page 36 requiring the participant to submit personal information. The request for information can comprise any other suitable type of request for information which is well-known to one having ordinary skill in the art.

As shown conceptually in FIG. 4, the web-based program 18 can comprise all of the above-mentioned elements, and each can be optionally displayed/provided to the participant in any order. It is noted that FIG. 4 is a conceptual view of the present invention, and that it is not intended to represent an actual visual output which is displayed to the participant. Preferably, the interactive webpage 20, the incentive 16, the survey 34 (when provided), and the registration page 36 (when provided) can be displayed individually and in any successive order.

In this embodiment of the present invention, a programming infrastructure 38 of the web-based program 18 is provided for by a provider. The infrastructure 38 of the web-based program 18 allows a sponsor to set up the web-based program 18 in a fully customizable manner. For instance, the sponsor decides: (1) whether to include a survey 34; (2) whether to include a registration page 36; (3) which order the interactive webpage 20, the survey 34 (if provided), the registration page 36 (if provided), and the incentive 16 are presented to the participant; (4) what content is incorporated into the interactive content 12; (5) what clue(s) 10 is/are provided; (6) the location and size of the selectable area(s) 14; (7) the number of clues 10 and correctly selected selectable areas 14 which are required before the incentive 16 is granted to the participant; (8) the number of incentives 16 granted to each participant; (9) whether (and if so, how) the type of incentive 16 is varied based upon information gathered from the participant on the survey 34 and/or registration page 36 (when provided); and so on. Within the confines of the infrastructure 38 provided by the provider, the sponsor can easily develop and set up a web-based program 18 for interacting with participants and providing the participants with an incentive 16.

In this regard, the provider can allow sponsors to quickly and easily set up their web-based program 18 using the infrastructure 38 at a cost which is substantially less than would be incurred for independently developing such an incentivized program.

Furthermore, while setting up the web-based program 18, the sponsor can predetermine the number of incentives 16 to be granted based on quantity, dollar value, date, or any other factor which is understood by one of ordinary skill in the art.

Since the web-based program 18 is operating through the infrastructure 38 provided by the provider, the provider can host the web-based program 18, and provide the sponsor with a hyperlink which allows the participants entry into the web-based program 18. According to this aspect, the sponsor can distribute the hyperlink using an existing distribution email list, by advertising using banner ads (wherein clicking on the banner ad directs the participant into the web-based program 18), and so forth.

In yet another aspect of the web-based program 18, the participant can be offered the opportunity to notify their contacts of the incentive 16 offered by the sponsor through the web-based program 18. For example, the participant can select contacts through a social networking site, or the participant can simply enter email addresses for forwarding the notification.

It should be understood that the present invention is not limited to the specific aspects described above. As mentioned above, the incentivized program 18 can operate on an Internet-wide basis, or it can operate with a non-Internet-based program.

It is to be understood that the present invention provides a fully customizable incentivized program which the sponsor can set up and operate according to his or her needs and demands. The incentivized program can be set up to require a single interaction with the interactive content in exchange for a coupon. It can also be set up to require extensive registration information, completion of an exhaustive survey, and a thorough interaction with the sponsor's interactive content before a more elaborate or valuable incentive is provided to the participant. The present invention contemplates an incentivized program which allows sponsors to utilize it according to their particular needs.

As is apparent from the preceding, the present invention provides an interactive incentivized program which is fully customizable and attracts participants to engage with the sponsor's interactive content.

What is claimed is:

1. A method for providing a participant with an incentive comprising:
(a) providing a web browser including a clue, an interactive content, and a pre-defined selectable area within the interactive content, the clue comprising information for directing the participant to select the pre-defined selectable area, and the selectable area having a location which is initially unknown to the participant;
(b) presenting the clue to the participant;
(c) deducing the location of the selectable area by the participant using the clue;
(d) selecting the selectable area by the participant; and
(e) providing an incentive to the participant for selecting the selectable area.

2. The method of claim 1 further including the step of presenting a request for information from the participant.

3. The method of claim 2 wherein the request for information is a survey.

4. The method of claim 2 wherein the request for information is a registration page requiring the participant to submit personal information.

5. The method of claim 2 further including the step of presenting a hint to the participant to aid the participant in deducing the location of the selectable area.

6. The method of claim 5 wherein the hint is presented to the participant after a predetermined period of time has lapsed.

7. The method of claim 2 wherein the selectable area is chosen from the group consisting of an image, text, or a hyperlink.

8. The method of claim 2 wherein the clue comprises text.

9. The method of claim 1 wherein the clue comprises text.

10. The method of claim 1 wherein the selectable area is chosen from the group consisting of an image, text, or a hyperlink.

11. The method of claim 1 further including the step of presenting a hint to the participant to aid the participant in deducing the location of the selectable area.

12. The method of claim 11 wherein the hint is presented to the participant after a predetermined period of time has lapsed.

13. An incentivized web-based computer program comprising:
(a) a clue containing information;
(b) an interactive content;
(c) a selectable area located within the interactive content, the location of the selectable area being unknown to a participant of the program, the information in the clue provided for directing the participant to select the selectable area; and
(d) an incentive which is made available to the participant upon selecting the selectable area.

14. The computer program of claim 13 comprising a request for information from the participant.

15. The computer program of claim 14 wherein the request for information includes a survey.

16. The computer program of claim 14 wherein the request for information includes a registration page requiring the participant to submit personal information.

17. The method of claim 13 wherein the clue comprises text.

18. The method of claim 13 wherein the selectable area is chosen from the group consisting of an image, text, or a hyperlink.

19. The method of claim 13 comprising a hint including additional information to aid the participant in deducing the location of the selectable area.

20. The method of claim 19 wherein the hint is presented to the participant after a predetermined period of time has lapsed.
